(19) United States
(12) Patent Application Publication
(10) Pub. No.: US 2007/0267376 A1
(43) Pub. Date: Nov. 22, 2007

(54) Pipe Layer Apparatus

(75) Inventor: Daniel E. Davis, San Benito, TX (US)

Correspondence Address: PATTERSON & SHERIDAN, L.L.P., 3040 POST OAK BOULEVARD, SUITE 1500, HOUSTON, TX, 77056, US

(73) Assignees: Andre Faure, Besancon (FR); Universite De Franche-Comte Direction De La Valorisation, Besancon Cedex (FR)

(21) Appl. No.: 10/548,768

(22) PCT Filed: Mar. 11, 2003
(86) PCT No.: PCT/US03/07613

§ 371 Date: Jun. 6, 2007

(51) Int. Cl. B66C 23/00

(52) U.S. Cl. 212/195

(57) ABSTRACT

The pipelayer crane apparatus (10) comprises a lower, the lower comprising a lower frame (100), a pedestal, a lower bearing portion, a telescoping axle, a track roller, and a track shoe, an upper, the upper (200) comprising a frame, a body, a cab, a pedestal, a upper bearing portion, and a counterweight, a lifting assembly, the lifting assembly (300) comprising an adjacent portion, a remote portion, a joint, and a weldment (400), the weldment comprising a body, an extension, a winch, and securing members. A method for a pipelayer crane apparatus to rotate about the track shoes comprising a lower, the lower having a pedestal attached to a lower bearing surface; an upper, the upper having a pedestal attached to a upper bearing portion; bearing formed by the interaction of the upper bearing surface and the lower bearing surface; a pipe lifting assembly, the pipe lifting assembly attached to a weldment, the weldment attached to the upper, and the upper rotating about the bearing formed by the upper bearing surface and the lower bearing surface.

Be it known that I, Daniel E. Davis, a citizen of the United States of America, residing at Harlingen, Tex. have invented a new, original and ornamental design for a PIPELAYER, of which the following is a specification, reference being made to the accompanying drawings which form a part thereof.

### DESCRIPTION

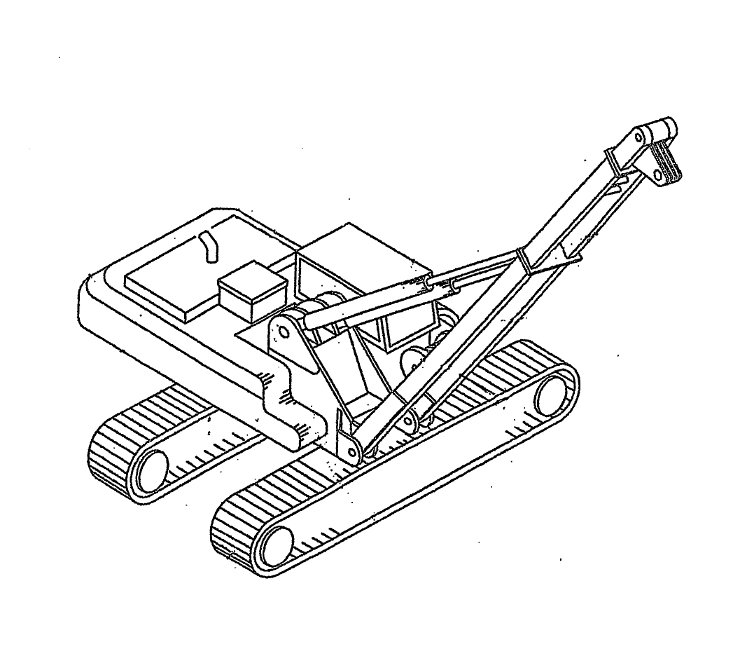

FIG. 1 is a perspective view of the pipelayer of the present invention rotated 90 degrees.

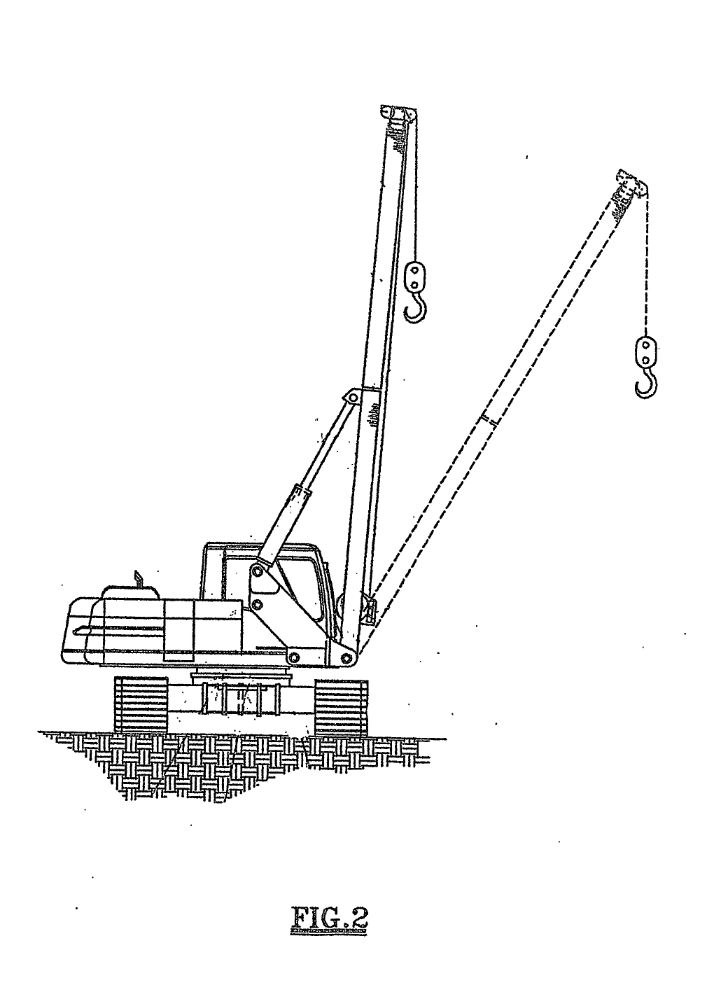

FIG. 2 is a side view of the pipelayer of the present invention as illustrated in FIG. 1.

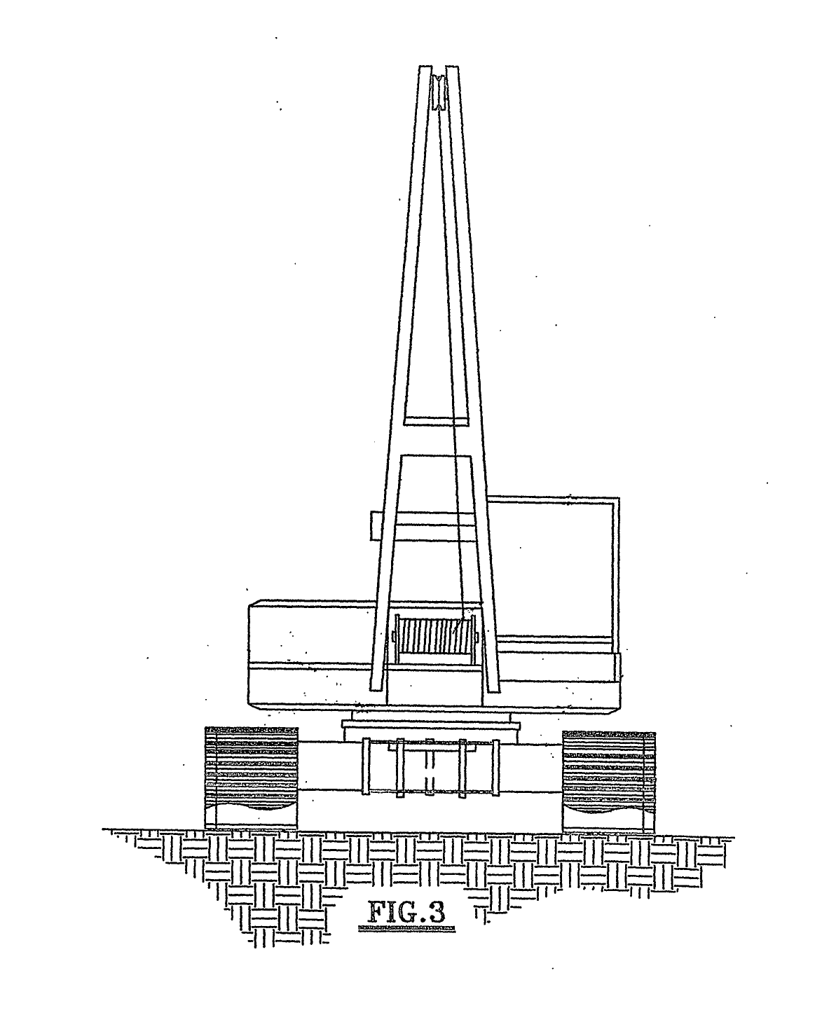

FIG. 3 is a front view of the pipelayer of the present invention as illustrated in FIGS. 1 and 2.

FIG. 4 is a perspective view of the pipelayer of the present invention rotated 90 degrees as illustrated in FIG. 1.

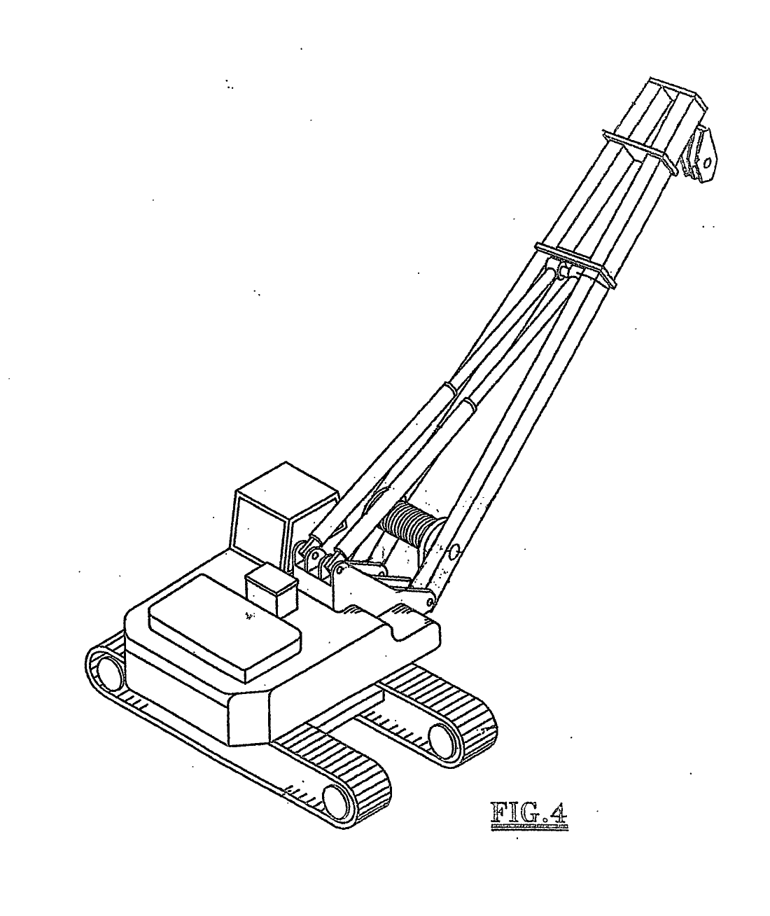

FIG. 5 is a perspective view of the pipelayer of the present invention.

FIG. 6 is a perspective view of the pipelayer of the present invention illustrated in FIG. 5 rotated 90 degrees.

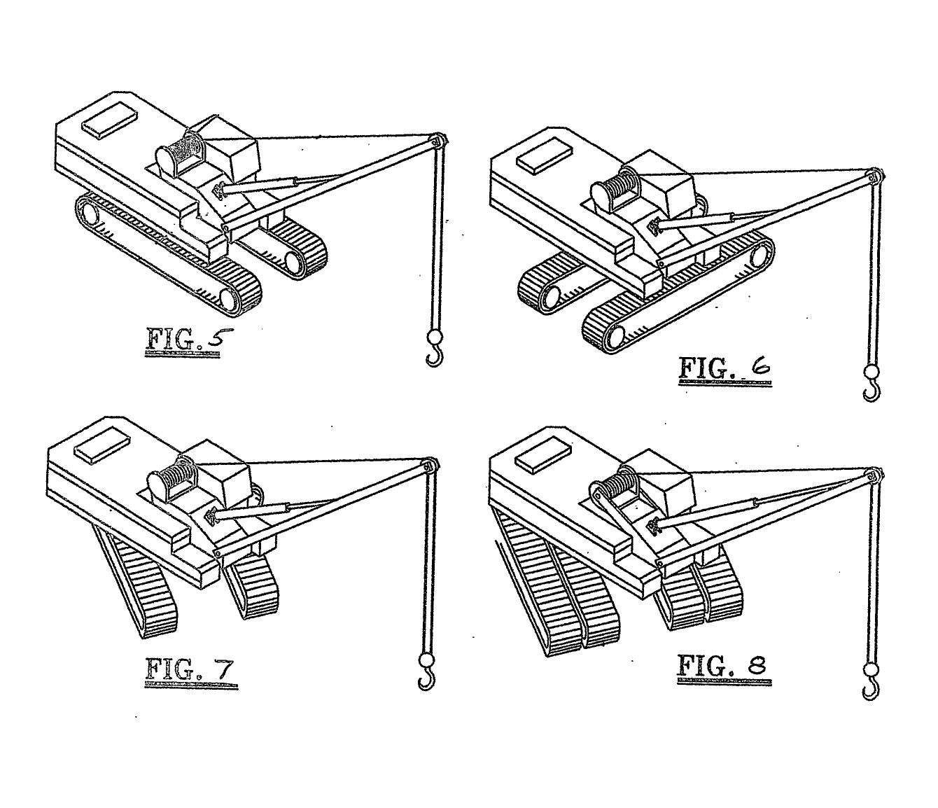

FIG. 7 is a perspective view of the pipelayer of the present invention illustrated in FIG. 5 rotated 45 degrees.

FIG. 8 is a perspective view of the pipelayer of the present invention similar to the embodiment illustrated in FIG. 5 rotated 45 degrees.

What is claimed is:

1. The ornamental design for a pipelayer, substantially as shown and described.
